(19) United States
(12) Patent Application Publication
(10) Pub. No.: US 2012/0198198 A1
(43) Pub. Date: Aug. 2, 2012

(54) Managing Line Items in a Computer-Based Modular Planning Tool

(75) Inventors: Michael Peter Gould, Yorkshire (GB); Dorian Lawrence Baverstock, Carmarthenshire (GB)

(73) Assignee: ANAPLAN, INC., Redwood City, CA (US)

(21) Appl. No.: 13/497,408

(22) PCT Filed: May 26, 2010
(86) PCT No.: PCT/GB2010/050876

§ 371 Date: Mar. 21, 2012

Related U.S. Application Data
(60) Provisional application No. 61/182,069, filed on May 28, 2009.

(51) Int. Cl. G06F 12/06

(52) U.S. Cl. 711/170; 711/E12.084

(57) ABSTRACT

A computer-implemented modular planning tool and method are provided which allow a line item (50) to be joined to another line item (50) so that data attributes (54), data structure (56) and data contained in the data structure (56) are shared by both line items (50). This is achieved using a join attribute of a line item (50) to point to another line item (50).

### BACKGROUND

1. Technical Field

The invention relates generally to computer-based planning tools, and in particular to a system and method of managing line items in a computer-based modular planning tool. In particular, but not exclusively, the invention finds utility in a business planning tool.

2. Description of Related Art

Many computer-based business planning tools use modules to contain and manage data. For example, there may be a module dedicated to handling SALES information, a module dedicated to calculating REVENUE information (derived from SALES), a module dedicated to calculating DIRECT COSTS (derived from SALES), and a module dedicated to calculating MARGIN SUMMARY (derived from SALES, REVENUE and DIRECT COSTS).

Within each module, there are normally a plurality of fundamental data storage elements. A fundamental data storage element is a structured set of data values representing, for example, operational data of a business or enterprise. These fundamental data storage elements are sometimes referred to as line items.

When designing a computer-implemented business planning tool, a question arises as to how to introduce and handle a new instance of an already existing line item. For example, a line item called UNITS SOLD may represent the number of units sold by a business, and is located in the SALES module. The data representing the number of units sold may also be needed in a separate module, such as REVENUE, DIRECT COSTS and MARGIN SUMMARY.

Generally speaking, existing computer-implemented business planning tools use either (a) a direct formula reference to another line item in a different module, or (b) a duplicate copy of a line item in the module of interest.

However, both of these approaches have significant disadvantages.

For example, when using a direct formula reference, full information regarding the line item to which a reference is made is not always available within the module that contains the line item making the reference. Additionally, the references can occur in unpredictable locations and are embedded in a formula which needs to be examined. This makes this approach difficult to manage and maintain. Also, broken references can occur when a module containing a referred to line item is removed from a model, for example, to substitute one module for another, in particular where both modules contain an equivalent line item. In practice, these broken references are difficult to fix.

The duplicate copy approach allows all of the information of the referred-to line item to be available locally within a module. Therefore, it is easier to predict the location of any references. However, there are disadvantages. For instance, duplicate data is created which is inefficient in terms of memory usage. Also, the duplicate line item must synchronise with the original line item to remain up-to-date, thereby creating overhead and maintenance issues.

In summary, the above two approaches significantly complicate model structures and the modelling process itself. They also negatively impact the maintainability, the intelligibility and extensibility of modular planning tools.

There is a commercial need for computer-based planning tools which are easier to maintain, understand and extend when compared with the prior approaches.

An aim of the invention is to provide such a computer-based business planning tool. At the very least, it is an aim of the invention to provide a system and method which attempts to solve at least one or more of the four above-mentioned problems with the prior art.

### SUMMARY OF THE INVENTION

According to the present invention there are provided methods, a computer-implemented planning tool, computer-implemented line items and a computer recordable storage medium as set forth in the appended claims. Other features of the invention will be apparent from the dependent claims, and the description which follows.

In a first aspect of the invention, there is provided a method of managing line items in a computer-based modular planning tool, the method comprising the steps of: creating a first module in a computer memory; adding a line item to the first module, the line item comprising a header, at least one data attribute defining operational data of the line item in terms of at least one of the size, type and derivation of the operational data, and a data structure holding the operational data in accordance with the at least one data attribute; creating a second module in the computer memory; adding a slave line item to the second module, the slave line item comprising a header and a joining attribute identifying the line item of the first module which becomes a corresponding master line item to the slave line item; and causing a computer processor to recognise the joining attribute identifying the master line item and to join the slave line item to the master line item, so that the slave line item shares the at least one data attribute and the data structure holding the operational data with the master line item.

In this way, unnecessary duplication of data is avoided. Also, it becomes much easier to track dependencies of line items using the join attribute. There is no need to synchronise or constantly update duplicate line items, as the data is held in a single place and is shared between two line items. Also, modules become much easier to remove from a model. Slave line items joined to line items in a removed module are simply joined to equivalent line items in a substitute module, and the dependency information needed is available at the slave line item.

The header of the master line item and the slave line item may each contain a name attribute used to identify the master line item and slave line item, respectively. Each name attribute of a line item may be unique within a respective module. The respective name attributes of the master line item and the slave line item may not be identical.

In one exemplary embodiment of the invention, the method further comprises the steps of: changing the joining attribute of the slave item to a NULL value; and causing the computer processor to recognise the NULL value of the joining attribute of the slave line item, and to un-join the slave line item from the master line item, so that the slave line item has an independent at least one data attribute and an independent data structure holding independent operational data.

In a second aspect of the invention, there is provided a method of managing line items in a computer-based modular planning tool, the method comprising the steps of: creating a first module in a computer memory; adding a first line item to the first module, the first line item comprising a header, a joining attribute set at NULL, at least one data attribute defining operational data of the first line item in terms of at least one of the size, type and derivation of the operational data, and a data structure holding the operational data in accordance with the at least one data attribute; creating a second module in the computer memory; adding a second line item to the second module, the second line item comprising a header and a joining attribute set at NULL, at least one data attribute defining operational data of the second line item in terms of at least one of the size, type and derivation of the operational data, and a data structure holding the operational data of the second line item in accordance with the at least one data attribute; changing the joining attribute of the second line item to identify the first line item; and causing a computer processor to recognise the joining attribute identifying the first line item and to join the second line item to the first line item, so that the second line item shares the at least one data attribute and the data structure holding the operational data of the first line item with the first line item.

In a third aspect of the invention, there is provided a computer-implemented planning tool, the planning tool comprising a computer memory arranged to store: a first module comprising a master line item, the master line item comprising a header, at least one data attribute defining operational data of the master line item in terms of at least one of the size, type and derivation of the first data, and a data structure holding the operational data in accordance with the at least one data attribute; and a second module comprising a slave line item, the slave line item comprising a header, a joining attribute identifying the master line item, the at least one data attribute of the master line item, and the data structure holding the operational data of the master line item.

In a fourth aspect of the invention, there is provided a computer-implemented line item existing in a module of a computer-based planning tool, the line item comprising: a header, a joining attribute identifying another line item existing in another module, at least one data attribute of the other line item, and a data structure holding the operational data of the other line item.

In a fifth aspect of the invention, there is provided a computer-implemented line item existing in a module of a computer-based planning tool, the line item comprising: a header, a joining attribute, at least one data attribute defining operational data of the line item in terms of at least one of the size, type and derivation of the operational data, and a data structure holding the operational data in accordance with the at least one attribute.

Optional features of the second through fourth aspects of the invention can be deduced from the optional features of the first aspect of the invention, where appropriate. Additional optional features of the invention can also be deduced from the following description of an exemplary embodiment of the invention.

At least some of the exemplary embodiments may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks. Also, elements of the exemplary embodiments may be configured to reside on an addressable storage medium and be configured to execute on one or more processors. That is, some of the exemplary embodiments may be implemented in the form of a computer-readable storage medium having recorded thereon instructions that are, in use, executed by a computer system. The medium may take any suitable form, but examples include solid-state memory devices (ROM, RAM, EPROM, EEPROM, etc.), optical discs (e.g. Compact Discs, DVDs, Blu-Ray discs and others), magnetic discs, magnetic tapes and magneto-optic storage devices. In some cases the medium is distributed over a plurality of separate computing devices that are coupled by a suitable communications network, such as a wired network or wireless network. Thus, functional elements of the invention may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Further, although the exemplary embodiments have been described with reference to the components, modules and units discussed below, such functional elements may be combined into fewer elements or separated into additional elements.

### BRIEF DESCRIPTION OF THE DRAWINGS

For a better understanding of the invention, and to show how exemplary embodiments may be carried into effect, reference will now be made to the accompanying drawings in which:

FIG. 1 is a schematic overview of a computer-implemented business planning tool according to the invention;

FIG. 2 is a schematic overview of an exemplary line item;

FIG. 3 is a schematic view of an exemplary data structure of the line item of FIG. 2;

FIG. 4 is another exemplary data structure of the line item of FIG. 2;

FIG. 5 is a schematic view of a modular arrangement of line items according to the invention;

FIG. 6 is a schematic view of two line items existing in separate modules;

FIG. 7 is a schematic view of joined line items existing in separate modules; and

FIG. 8 is a schematic view of two line items, previously joined, which have been separated.

### DETAILED DESCRIPTION OF THE EXEMPLARY EMBODIMENTS

Exemplary embodiments of the invention are now described, by way of example only, with reference to the accompanying drawings.

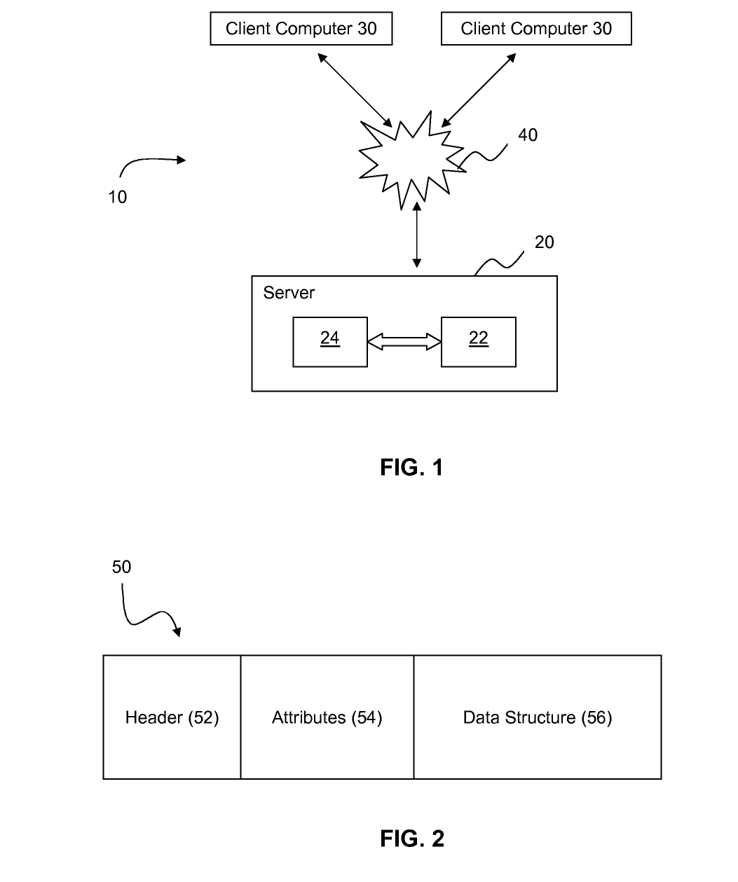

With reference to FIG. 1, a schematic overview of a computer-implemented business planning tool 10 is shown. The business planning tool 10 comprises a server 20 connected to a plurality of client computers 30 through a computer network 40.

The server 20 is arranged to store and process the main elements of the business planning tool 10, including all of the business planning tool 10 functions and operational data. The client computers 30 are arranged to access the business planning tool 10 via the computer network 40 and are able to send configuration and update commands to the server 20 in order to update the business planning tool 10.

In particular, the server 20 comprises a computer memory 22, such as random access memory (RAM), arranged to store system data, including operational data specific to the business planning tool 10. The server 20 also comprises a processor 24 which is arranged to execute computer-executable instructions which bring the business planning tool 10 to life. In practice, a user can create one or more business planning models using the business planning tool 10, and can manipulate the structure of each business planning model and data within each model. The structure of a business planning model is changed by redefining how data interacts to produce a desired set of outputs from a defined set of inputs. Data within each model is changed either by redefining how data is derived or by changing the data values themselves.

The computer-executable instructions define how the business planning tool 10 operates. For example, the computer-executable instructions, when run on a computer, (a) define and create data storage elements, or line items, for storing operational data; (b) define how the operational data interrelates with other operational data; (c) define how data is input to and output from the business planning tool 10; and (d) define how data is updated in response to user manipulation of a business planning model. This invention touches on operations (a) to (c).

With this in mind, it is useful to define a fundamental data storage element, as this is important to developing an understanding of the invention. A fundamental data storage element in the context of the invention is a line item. At a general level a line item is a structured set of data values representing and holding operational data. In the exemplary embodiment, operational data represents recognisable activities within a business or enterprise, that is, things that drive or measure business performance. Line items are used to represents a business driver, business account or a business measurement. Some examples of data to be represented by a line item are listed in Table I.

In the system 10 of the invention, the computer memory 22 is arranged to store line items 50.

FIG. 2 shows an exemplary line item 50 of the system 10. In practice, each line item 50 of the system 10 comprises a header 52 arranged to indicate what the line item 50 represents via a name attribute, a set of data attributes 54 defining the operational data to be stored by the respective line item 50, and a data structure 56 to hold the operational data.

TABLE I

| Line Item | Type |
|---|---|
| Units Sold | Business Driver - Used to model revenue and |
| | direct costs |
| Sales Tax Rate | Business Driver - Used to calculate sales tax |
| Headcount | Business Driver - Used to calculate future |
| | employees costs |
| Revenue | Business Account - Income |
| Cost of Goods Sold | Business Account - Expenses |
| Trade Creditors | Business Account - Liability |
| Cash at Bank | Business Account - Assets |
| Gross Margin Percentage | Business Measurement - a key ratio |

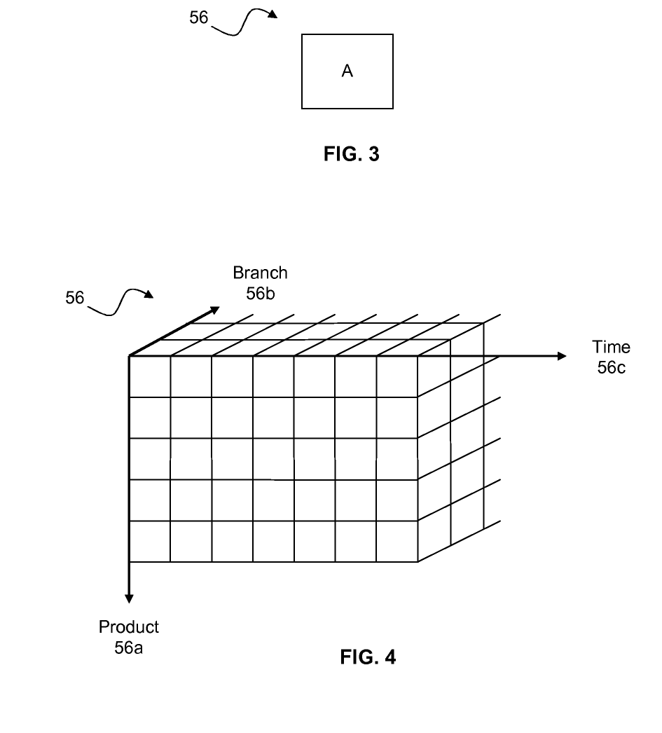

FIG. 3 shows one exemplary data structure 56 which could be used.

Here, the line item 50 represents operational data having a single value A. In practice, this value might represent “Sales Tax Percentage” and be equal to 15 percent, depending on the prevailing rate of sales tax. This is an example of a line item used to represent a business driver.

FIG. 4 shows a more complex data structure 56.

Here, the data structure 56 holds operational data having many values arranged in three dimensions, namely a product dimension 56a, a branch dimension 56b and a time dimension 56c. The values contained in the data structure 56 may represent a business driver, business account or business measurement. In practice, the values may represent “Number of Units Sold”, “Price”, or “Discount %” if the operational data is primary data, the values may represent “Gross Sales”, “Discount” or “Revenue” if the operational data is secondary data, to give a few examples.

As mentioned already, each line item 50 has a set of data attributes 54 which define the operational data and the data held by the line item 50. An exemplary set of data attributes 54 is shown in Table II, in the context of seven example line items 50.

In the exemplary embodiment, the set of data attributes 54 comprises five data attributes, namely (i) Primary/Secondary, (ii) Dimensions (which also indicates size), (iii) Type, (iv) Summary and (v) Balances.

TABLE II

| | Data Attributes (54) | | | | |
|---|---|---|---|---|---|
| | (i) | (ii) | | (iv) | (v) |
| Header (52) | Primary/ | Dimen- | (iii) | Sum- | Bal- |
| Name | Secondary | sions | Type | mary | ances |
| Sales Tax | NULL | — | General | None | None |
| Percentage | | | Number | | |
| No. of Units | NULL | Product | General | Sum | None |
| Sold | | Branch | Number | | |
| | | Time | | | |
| Price | NULL | Product | Monetary | None | None |
| | | Time | | | |
| Gross Sales | No. of Units | Product | Monetary | Sum | None |
| | Sold × Price | Branch | | | |
| | | Time | | | |
| Discount % | NULL | Branch | General | None | None |
| | | | Number | | |
| Discount | Gross Sales × | Product | Monetary | Sum | None |
| | Discount % | Branch | | | |
| | | Time | | | |
| Revenue | Gross Sales − | Product | Monetary | Sum | None |
| | Discount | Branch | | | |
| | | Time | | | |

The first data attribute, (i) Primary/Secondary, is arranged to specify whether the operational data stored in the data structure 56 is primary data or secondary data. In this context, primary data is sourced externally from the system 10. An example of primary data is data imported electronically from another system, or from a spreadsheet or other electronic document, or data entered manually by a user. Secondary data by contrast is data which is derived from other operational data. In the exemplary embodiment, secondary data is derived from operational data stored in at least one other line item 50. If the first operating attribute specifies that the operational data stored in the line item 50 is secondary data, then the first operating attribute also specifies how the operational data is derived.

In practice, primary data is specified by a NULL entry in the first operating attribute. This is seen in Table II for the line item “Sales Tax Percentage”.

Secondary data is specified by the presence of a formula in the first operating attribute describing how the operational data is calculated from operational data stored in the at least one other line item 50. This is seen in Table II for the line item “Gross Sales”, which has a formula of “No. of Units Sold vs Price”.

However, a three-way choice of NULL, primary or secondary is envisaged, wherein NULL means a choice of primary vs. secondary has not yet been specified.

The second data attribute, (ii) Dimensions, is arranged to specify which dimensions of the model appear in the respective line item 50.

For example, in the example data structure 56 of FIG. 3, the second data attribute would specify that the line item 50 is representative of a single operational data value having no dimensions.

Alternatively, considering the example data structure 56 of FIG. 4 having three dimensions (product 56a, branch 56b and time 56c), the second data attribute would specify that the line item 50 is representative of operational data values in three dimensions, and specifies the dimensions of the model which form part of the line item 50. Conceptually, the data represented by this example line item may be thought of as being organised in a three-dimensional array as shown in FIG. 4. Of course, line items having a single dimension (“Discount %”), or two dimensions (“Price”) are also possible, and are illustrated in Table II.

The second data attribute, (ii) Dimensions, also allows the system 10 to know how to handle operations concerning different line items 50. For example, line item “Discount %” in the example has only a single dimension and applies only to branches within the model.

The third data attribute, (iii) Type, is arranged to specify the type of data represented by a line item 50. Broadly speaking, data is categorised as either numerical data or non-numerical data. Within these categories, numerical data is further broken down into general number-type data or monetary-type data. This enables the system 10 to recognise monetary values so that currency conversion, for example, may be performed to normalise performance over different territories in a business. Also, non-numerical data may be further broken down into Boolean or text data, again to enable the system 10 to handle that data appropriately.

For example, in the examples listed in Table II, “Sales Tax Percentage” is classified as general number-type data, and “Price” is classified as monetary-type data.

The fourth data attribute, (iv) Summary, is arranged to specify how the relevant line item 50 is treated at summary levels. This is typically by summing certain data along a dimension, for example, summing monthly sales figures into quarterly sales figures. Instead of a simple summation, the derivation for a line item 50 (i.e. the formula) may be used at the summary levels.

The fifth operating attribute, (iv) Balances, is arranged to specify how line items 50 which handle balance information should be handled. Such line items include “Asset” and “Liability” accounts, and also information relating to “Headcount”. This operational data is measured at points in time (such as at the end of each month), with movements in and out during the period in between.

The data structure 56 is determined based on the data attributes 54. For example, memory is allocated for each line item depending on the no. of dimensions selected and the type of data represented, for example general number, monetary, Boolean or text. The number of values per dimension is arranged to change as a user modifies the dimension, and this information is important in the management of each data structure 56. Suitable mapping is used to manage the insertion of values into line items. In other words, spaces are created (and perhaps filled where possible) in line items to compensate for the addition of one or more members in a dimension that applies to those line items.

Table III illustrates system information used to maintain data structures for the line items shown in Table II. Here, the no. of dimensions is shown for each line item, together with the no. of values per dimension. In this example, there are 100 values in the product dimension, 50 values in the branch dimension and 24 values in the time dimension. This information is derived from the data attribute (ii) Dimensions. The exact memory requirement is derived using this information, and from the type of data stored from the data attribute (iii) Type.

Tables II and III show example line items 50 which represent example types of operational data, such as “No. of Units Sold”, “Price”, “Gross Sales” etc. However, other types of operational data are envisaged, sharing the dimensions “Product”, “Branch” and “Time”, but which could also introduce other dimensions into a model.

In the exemplary embodiment, a pre-configured line item 50 may be conveniently chosen from a pre-configured but extensible list. The number of values in a particular dimension may be pre-configured by a user, or may be arranged to expand as data is added, with changes rippling through the model to all line items sharing that dimension.

Additionally, the system 10 allows a user to fully customise each line item 50 by configuring all of the data attributes 54.

TABLE III

| | Data Structure (56) | |
|---|---|---|
| Header (52) | No. of | No. of Values |
| Name | Dimensions | per Dimension |
| No. of Units Sold | 3 | Product—100 |
| | | Branch—50 |
| | | Time—24 |
| Price | 2 | Product—100 |
| | | Time—24 |
| Gross Sales | 3 | Product—100 |
| | | Branch—50 |
| | | Time—24 |
| Discount % | 1 | Branch—50 |
| Discount | 3 | Product—100 |
| | | Branch—50 |
| | | Time—24 |
| Revenue | 3 | Product—100 |
| | | Branch—50 |
| | | Time—24 |

Predetermined units for certain of the dimensions may also be specified in the system 10, for example time is measured in months and years, such as 2008-10 for October 2008. Also, each line item 50 may include totals and sub-totals of values within each dimension. For example, the forecast of total products sold in the first quarter of 2009 for a particular branch, in addition to the monthly sales figures.

In this way, the system 10 is able to create suitably sized line items 50 for storing the respective operational data. A user is able to input as much data as required to suit the business to be modelled, over a suitable time frame. A user is not forced to include more detail than is required, thus avoiding spurious data. All of this results in an easier to use and more efficient system 10.

Also, the system 10 is able to handle automatically line items 50 of varying dimensions, sizes and granularity.

As mentioned above, the system 10 uses line items 50 to represent operational data.

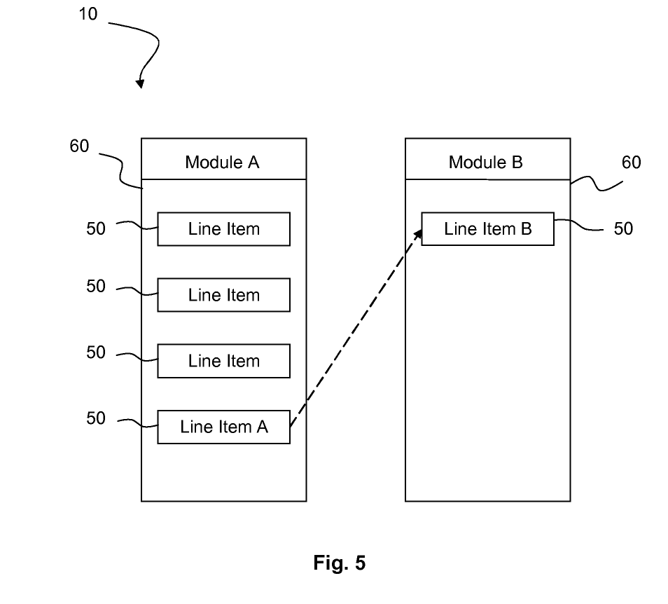

Additionally, there is a desire in business planning tools to adopt a modular approach. This greatly helps with organisation, clarity, expression of processes and assignment of responsibility within a planning tool. However, it is often necessary to introduce new instances of the same line item 50 in separate modules 60, as shown in FIG. 5.

For example, FIG. 5 shows two modules 60, namely MODULE A and MODULE B. MODULE A handles SALES information. MODULE B handles, in this example, REVENUE information. Line item A contained in MODULE A is also required in MODULE B. In this example, line item A represents the “No. of Units Sold”.

According to the invention, in order to introduce the data represented by line item A into MODULE B, a new line item B is created in MODULE B.

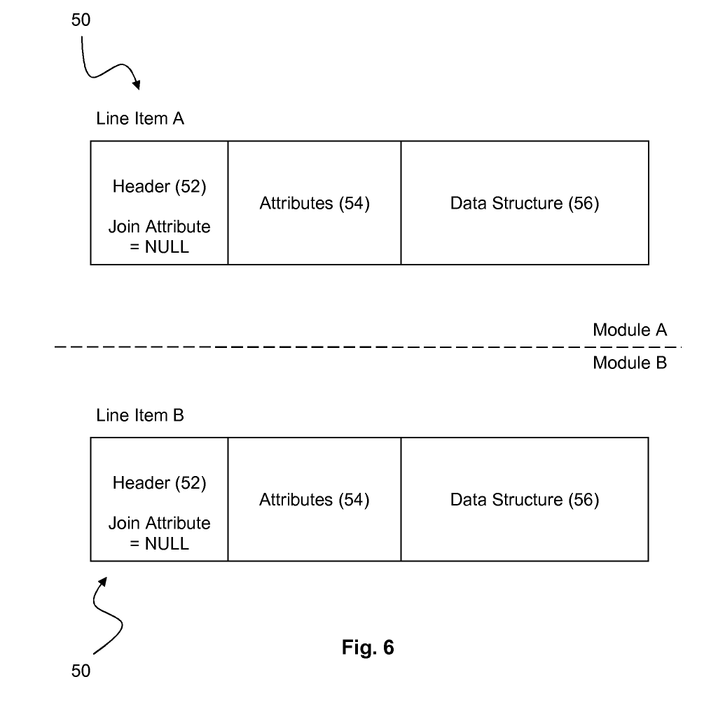

FIG. 6 illustrates line item A located in MODULE A, and line item B located in MODULE B. Initially, line item B exists independently from line item A in the system 10. Both line item A and line item B have independent headers 52, attributes 54 and data structures 56. As line item A has already been created, then the attributes 54 and the data structure 56 containing operational data have already been set up. In the case of line item B, the attributes 54 are yet to be set up by a user, together with the data structure 56 and data to be held therein. In the system 10, the user is able to select from a number of pre-defined line items, and is able to select attributes 54 from a drop-down list in order to create the corresponding data structure 56. Alternatively, a skeleton line item can be created in which the user has to define all of the attributes 54 creating the data structure 56.

In this case, where line item B is to represent the same data as line item A, there is no need to specify attributes 54 and a data structure 56 for line item B. Instead, the user joins line item B to line item A.

In other words, the invention uses a process of joining line item B in MODULE B to line item A in MODULE A, where the respective line items each represent the same operational data, for example, the “No. of Units Sold”.

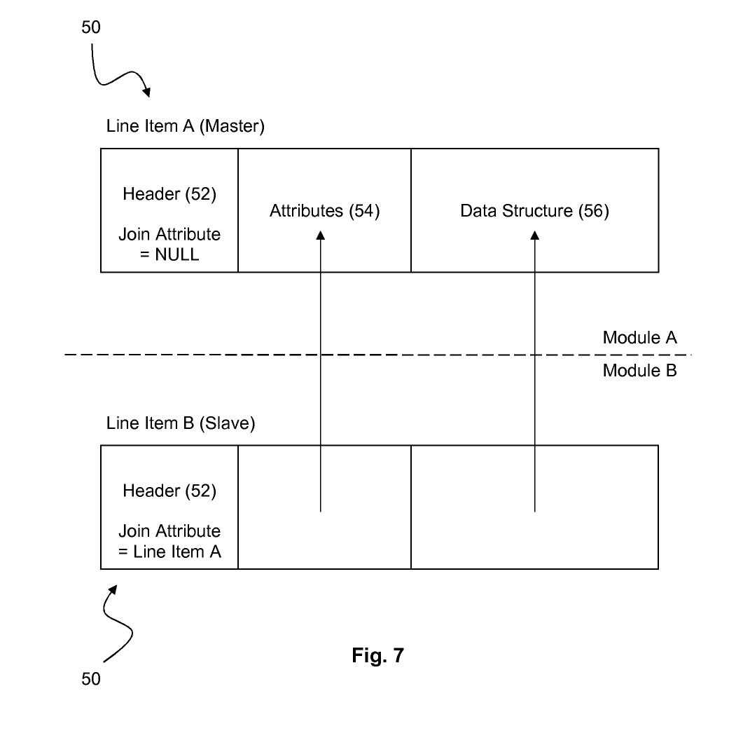

In practice, this is achieved by using a join attribute in the header 52 of line item B (the slave line item) in MODULE B. The join attribute is set to refer to line item A in MODULE A, which then becomes the master line item. This is shown in FIG. 7.

When two line items 50 are joined in this way, then the data held in the data structure 56 of the master line item may be accessed directly by the master line item, or alternatively, by the slave line item. There is no need to duplicate the data held in the data structure 56. Also, there is no need for the slave line item to have its own set of attributes 54 defining the data structure 56. As the data is shared, the attributes 54 are also shared.

Referring to FIG. 7, it is clear that the join attribute of line item B (the slave line item) points directly to line item A (the master line item), and that the attributes 54 and data structure 56, including the data, are shared.

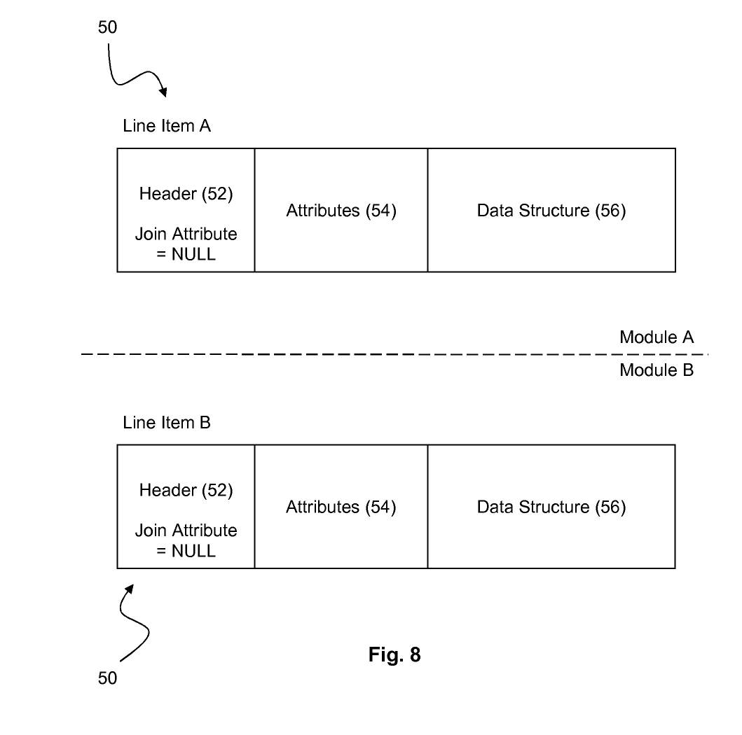

FIG. 8 shows a situation in which line item B (the slave line item) is separated from line item B by entering a NULL as the entry for the join attribute. When this occurs, the attributes 54 and data structure 56 of line item B (formerly the slave line item) can be specified by a user. In practice, the attributes 54 and data structure 56 of line item B immediately previous to joining are used.

To summarise the invention, if a line item 50 is joined to another line item 50, then attributes 54, data structure 56 and data are shared by both line items 50. The original line item becomes a master line item, and the line item which has been joined to the original line item becomes a slave line item. This process can be undone by entering a NULL value in the join attribute of the slave line item.

Also, the system 10 is able to automatically create slave line items 50 when an old module 60 is split into two or more new modules 60. In this case, the system 10 is arranged to recognise references to line items 50 which no longer exist in one of the at least two new modules 60, because, due to the split, the line items 50 are in another new module 60. The system 10 automatically creates a slave line item 50 joined to the line item of interest in the appropriate module 60, so that the local references within the respective module remain intact. This is particularly useful in creating a dynamic easy to use system 10. The slave line items 50 created in this way share the same name attribute as the corresponding master line items to which they are joined.

The system 10 is also able to create slave line items 50 in modules 60 automatically through a selection made on another line item 50. For example, if a user wishes to create slave line items 50 joined to the line item “No. of Units Sold” appearing in the SALES module, then the user can select the line item “No. of Units Sold” and specify that slave line items are to appear in the REVENUE and DIRECT COSTS modules. The system 10 automatically creates the slave line items 50 in the corresponding modules 60 and allows a user to specify the name attributes for the slave line items 50, if desired.

As mentioned above, the header 52 of each line item 50 comprises a name attribute which represents the respective line item 50 in a module 60. The name attribute is unique within a module 60. However, master and slave line items 50, each within different modules 60, may have a different name attribute, and in some cases it is preferable to assign a different name attribute to joined line items. For example, a master line item may have a name attribute TOTAL PRODUCTS SOLD in a sales module. A joined line item may simply be called UNITS SOLD in a related module used to calculate REVENUE.

If a master line item 50 contains primary data, and in particular data entry by a user, then a slave line item 50 also appears to a user as data entry and individual values can be edited by a user when accessing the slave line item 50. This makes it possible to change data values wherever they appear in a model, rather than having to navigate to the first instance of the data. Also, it is useful to know which line items in a model are actually data entry and this will be apparent in the invention. Where a formula reference is used for multiple instances, then only one instance of data entry will appear, even though many line items will refer to the data entry line item.

With regard to imported data, the data can be changed by a user by accessing either a master line item 50 representing that data, or a slave line item 50, joined to the master line item 50.

If the data represented by a master line item 50 and a slave line item 50 is derived from other data, that is, the data is secondary data, then the derivation of the secondary data is made known to a user whether or not the user is looking at the master line item 50 or the slave line item 50. This differs from existing modelling tools, in which the first instance of a line item has the genuine calculation used for the derivation, but all other instances contain only a reference to another instance of the line item.

The term slave line item is used to describe any line item which is joined to another by its joining attribute. The term master line item is used to describe any line item which is not joined to another line item by its joining attribute (i.e. the joining attribute=NULL), but to which a slave line item is joined by virtue of the joining attribute of the slave line item.

If a slave line item is joined to another slave line item, then both are considered slave line items. If the master line item in this situation is removed, then the first level slave line item must be reconfigured to become a master line item (by setting the joining attribute to NULL) or must be joined to another line item. The second level slave line item continues to point and be joined to the first level slave line item. This daisy-chaining helps with swapping modules in a model, as the number of re-joining operations may be reduced. However, even the second level slave line item allows a user to manipulate and view the data attributes 54, data structure 56 and data of the master line item, creating advantageous transparency.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-10. (canceled)

11. A method of managing line items in a computer-based modular planning tool, the method comprising the steps of:
creating a first module in a computer memory;
adding a line item to the first module, the line item comprising a header, at least one data attribute defining operational data of the line item in terms of at least one of the size, type and derivation of the operational data, and a data structure holding the operational data in accordance with the at least one data attribute;
creating a second module in the computer memory;
adding a slave line item to the second module, the slave line item comprising a header and a joining attribute identifying the line item of the first module which becomes a corresponding master line item to the slave line item; and
causing a computer processor to recognize the joining attribute identifying the master line item and to join the slave line item to the master line item, so that the slave line item shares the at least one data attribute and the data structure holding the operational data with the master line item.

12. The method of claim 11, wherein the header of the master line item and the slave line item each contain a name attribute used to identify the master line item and slave line item, respectively.

13. The method of claim 12, wherein each name attribute of a line item is unique within a respective module.

14. The method of claim 12, wherein the respective name attributes of the master line item and the slave line item are not identical.

15. The method of claim 11, further comprising the step of:
changing the joining attribute of the slave item to a NULL value; and
causing the computer processor to recognize the NULL value of the joining attribute of the slave line item, and to un-join the slave line item from the master line item, so that the slave line item has an independent at least one data attribute and an independent data structure holding independent operational data.

16. A method of managing line items in a computer-based modular planning tool, the method comprising the steps of:
creating a first module in a computer memory;
adding a first line item to the first module, the first line item comprising a header, a joining attribute set at NULL, at least one data attribute defining operational data of the first line item in terms of at least one of the size, type and derivation of the operational data, and a data structure holding the operational data in accordance with the at least one data attribute;
creating a second module in the computer memory;
adding a second line item to the second module, the second line item comprising a header and a joining attribute set at NULL, at least one data attribute defining operational data of the second line item in terms of at least one of the size, type and derivation of the operational data, and a data structure holding the operational data of the second line item in accordance with the at least one data attribute;
changing the joining attribute of the second line item to identify the first line item; and
causing a computer processor to recognize the joining attribute identifying the first line item and to join the second line item to the first line item, so that the second line item shares the at least one data attribute and the data structure holding the operational data of the first line item with the first line item.

17. A computer-implemented planning tool, the planning tool comprising a computer memory arranged to store:
a first module comprising a master line item, the master line item comprising a header, at least one data attribute defining operational data of the master line item in terms of at least one of the size, type and derivation of the first data, and a data structure holding the operational data in accordance with the at least one data attribute; and
a second module comprising a slave line item, the slave line item comprising a header, a joining attribute identifying the master line item, the at least one data attribute of the master line item, and the data structure holding the operational data of the master line item.

18. A computer-implemented line item existing in a module of a computer-based planning tool recorded in a computer readable storage medium, the line item comprising:
a header, a joining attribute identifying another line item existing in another module, at least one data attribute of the other line item, and a data structure holding the operational data of the other line item.

19. A computer-implemented line item existing in a module of a computer-based planning tool recorded in a computer readable storage medium, the line item comprising:
a header, a joining attribute, at least one data attribute defining operational data of the line item in terms of at least one of the size, type and derivation of the operational data, and a data structure holding the operational data in accordance with the at least one attribute.

20. A computer-implemented planning tool recorded in a computer readable storage medium, said planning tool comprising program instructions that when executed by a computer processor cause said computer processor to:
create a first module in a computer memory;
add a line item to the first module, the line item comprising a header, at least one data attribute defining operational data of the line item in terms of at least one of the size, type and derivation of the operational data, and a data structure holding the operational data in accordance with the at least one data attribute;
create a second module in the computer memory;
add a slave line item to the second module, the slave line item comprising a header and a joining attribute identifying the line item of the first module which becomes a corresponding master line item to the slave line item; and
recognize the joining attribute identifying the master line item and to join the slave line item to the master line item, so that the slave line item shares the at least one data attribute and the data structure holding the operational data with the master line item.

21. A computer-implemented planning tool recorded in a computer readable storage medium, said planning tool comprising program instructions that when executed by a computer processor cause said computer processor to:
create a first module in a computer memory;
add a first line item to the first module, the first line item comprising a header, a joining attribute set at NULL, at least one data attribute defining operational data of the first line item in terms of at least one of the size, type and derivation of the operational data, and a data structure holding the operational data in accordance with the at least one data attribute;
create a second module in the computer memory;
add a second line item to the second module, the second line item comprising a header and a joining attribute set at NULL, at least one data attribute defining operational data of the second line item in terms of at least one of the size, type and derivation of the operational data, and a data structure holding the operational data of the second line item in accordance with the at least one data attribute;
change the joining attribute of the second line item to identify the first line item; and
recognize the joining attribute identifying the first line item and to join the second line item to the first line item, so that the second line item shares the at least one data attribute and the data structure holding the operational data of the first line item with the first line item.
